(19) United States
(12) Patent Application Publication
(10) Pub. No.: US 2004/0024606 A1
(43) Pub. Date: Feb. 5, 2004

(54) Method of constructing an econometric meter

(76) Inventor: Ethelbert Chukwu, Raleigh, NC (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/332,693

(22) PCT Filed:
(86) PCT No.: PCT/US01/41378

(51) Int. Cl. G06F 17/60

(52) U.S. Cl. 705/1; 705/7; 705/10

(57) ABSTRACT

The present invention includes a method of constructing a controllable, stable, time-based, dynamic, and/or continuous economic model of an economic state of a system, such that the economic model is derived from at least one equation that includes an economic state function, an economic variable, an economic strategy, or any combination of any of these. The present invention further includes a method of constructing an econometric meter that includes the economic model, such that the econometric meter is effective to monitor, program, analyze, or predict one or more changes to an economic state of a system, such as a nation.

### CROSS-REFERENCE TO RELATED APPLICATION(S)

This application claims priority from Provisional Patent Application No. 60/218,009 filed on Jul. 12, 2000 entitled CONSTRUCTION OF AN ECONOMETRIC METER, by Ethelbert N. Chukwu.

### BACKGROUND OF THE INVENTION

The present invention generally relates to a field of macroeconomics. More specifically, the present invention relates to a system and method for constructing and utilizing an econometric meter. The econometric meter of the present invention is capable of accurately monitoring, analyzing, programming, and/or predicting an evolution of an economic state.

Each individual, firm, or nation must decide on how to use a limited amount of a resource, such as a machine, a factory, a natural resource (capital), labor wages, investment, or the like in order to satisfy a desire. An economic system generally describes an arrangement or an organized set of procedures that may be used to facilitate the decision-making process for using the limited resource. Generally, the economic system may also be described in terms of an economic state of the system. The economic state of the system describes the economic system at a specified time and/or over a specified time period.

However, prior to making the decision on how to use a limited resource, an accurate understanding of the economic state for the system is required. Unfortunately, the economic state for the system may be complex and abstract and therefore, challenging to describe. Furthermore, understanding the economic state of the system may prove more difficult, since the economic state may be dynamic and change at an uneven rate that is often arduous to study.

Previous attempts to define or understand the economic state for a system has resulted in development of economic models that may be characterized as (1) uncontrollable, (2) simplistic, (3) unstable, (4) time-discrete, and/or merely (5) inaccurate. By uncontrollable is meant that an-economic model is not capable of being manipulated to achieve any desired outcome of the economic state from an initial state. The term “uncontrollable” is also meant to encompass an economic model that is characterized by a wide fluctuation in one or more economic variables over time.

As used herein, the term “unstable” refers to an economic model that is not capable of achieving a consistent and reproducible result within a given set of boundaries and/or parameters. Similarly, the term “time-discrete”, as used herein, refers to one or more economic variables of an economic model that incorporates only a finite or a whole number of values as a function of time, which may not permit the accurate characterization of a past economic state, nor permit accurate forecasting of an impact of a decision on a future economic state.

As used herein, the term “simplistic” refers to an economic model that is not capable of accommodating two or more dynamic and/or time-based economic variables, economic state functions, economic strategies, or any combination of any of these, that may be defined in terms of other economic variables, economic state functions or economic strategies. The term “inaccurate” refers to a poor fit of any economic data to an economic model, such that the economic model is unable to realistically determine an evolution of an economic state from the economic model.

Therefore, there exists an urgent need to construct a dynamic, time-based economic model that is effective to (1) accurately characterize a current economic state of a system, (2) accurately characterize a past economic state of the system, (3) accurately analyze a past and/or a current economic state, and (4) accurately forecast a future economic state of the system. In addition, there exists an urgent demand for construction of an econometric meter based on the economic model that is capable of accurately proving that an economic state of a system is controllable, stable and may be manipulated to a more desired economic state.

In addition, many tumultuous changes have occurred in the economic state of nations during the last several decades. Unfortunately, these tumultuous changes have resulted in rapid dwindling of scarce resources, high unemployment, high inflation, low productivity, sky-rocketing national debt, and an inability to implement sound economic policies that promulgate controllable, stable and sustainable economic growth.

In addition, some economists believe that current widely fluctuating stock prices, increasing inflation and unemployment, and decreasing economic growth being observed today are a result of past economic policies. Therefore, an urgent need exists (1) to stabilize or stimulate the economic state for a nation, and (2) to program economic growth of the economic state for a nation. This is the primary aim of the invention.

### BRIEF SUMMARY OF THE INVENTION

The present invention includes a method of constructing a controllable, stable, time-based, dynamic, and/or continuous economic model of an economic state of a system, such that the economic model is derived from at least one equation that includes an economic state function, an economic variable, an economic strategy, or any combination of any of these. The present invention further includes a method of constructing an econometric meter that includes the economic model, such that the econometric meter is effective to monitor, program, analyze, or predict one or more changes to an economic state of a system, such as a nation.

### BRIEF DESCRIPTION OF THE DRAWINGS

FIG. 1 is a schematic of a method for constructing an econometric meter in accordance with the present invention.

FIG. 2 is a schematic of a method for using an econometric meter in accordance with the present invention.

FIGS. 3-15 show how accurate the economic model is in predicting an equation that fits the data. FIGS. 3-15 each illustrate an economic variable as a function of time. The US variables are private consumption, exports, investments, government consumption, money demand, aggregate demand, consumer prices, income, income/government, income/export, balance of payment, long (income), and increase in stock. The “real” data, or data obtained from the International Financial. Statistic Yearbook, 1994, for USA, while the economic model data are the “+” markings.

### DETAILED DESCRIPTION

The present invention relates to a system and method for constructing and utilizing an econometric meter. More specifically, the present invention relates to an econometric meter that is capable of monitoring, analyzing, programming, and/or predicting an evolution of an economic state using the econometric meter and to a method of designing and making this econometric meter.

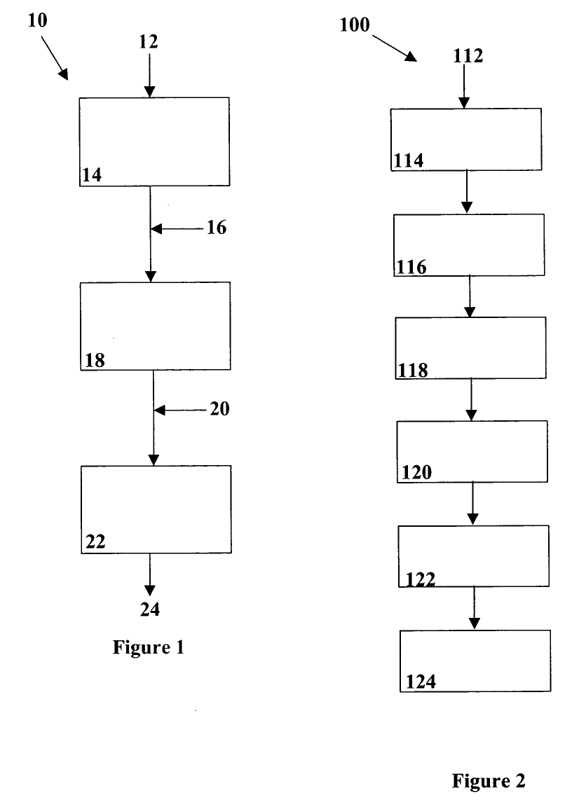

A method for constructing an econometric meter that is effective to define an economic state of a system is generally depicted at 10 in FIG. 1. In the method 10, a user 12 constructs and/or derives one or more equation(s) (step 14) that are capable of characterizing an economic state of a system to form a model 16 of the economic state of the system. Next, the model 16 of the economic state is used to design and/or identify one or more electronic circuits (step 18) to form one or more modeled-electronic circuit(s) 20, such that a current and/or a voltage of the modeled-electronic circuit(s) (not shown) is capable of characterizing and/or simulating the model 16 of the economic state.

Next, the modeled-electronic circuit(s) 20 may be assembled (construct) as part of an apparatus (step 22) to form the econometric meter 24 of the present invention. The econometric meter 24, hereinafter referred to as the “meter 24”, may be assembled as part of a simulator or a computer processing unit. The meter 24 is therefore capable of executing the electronic circuit designed in step 18. Furthermore, the meter 24 is capable of monitoring, analyzing, programming, simulating and/or predicting the evolution of the economic state. The term “evolution”, as used herein, refers to a time-based process in which a change from an original state to a different state is observed.

It has been discovered that using one or more economic variables, economic state functions, and economic strategies to derive one or more mathematical equations may be used to construct a model of an economic state that provides an accurate, time-based, dynamic, continuous characterization of the economic state. Furthermore, the economic state maybe characterized as a neutral game of pursuit in which a “quarry” is a government intervention strategy and a “pursuer” is a private control strategy. Such a characterization of the economic state permits construction of an econometric meter that may be used to test for controllability, stability and oscillation of the economic state. Such testing is beneficial to detect a looming economic depression or boom in the economic state. In addition, it has been discovered that the econometric meter is capable of determining how much government intervention is required for the economic state.

As used herein, the term “time-based” refers to an economic model that is evaluated as a function of time. Similarly, the term “dynamic” refers to an economic model that is capable of changing as a function of time and/or capable of being responsive to change. Likewise, the term “accurate” refers to a good fit of economic data to an economic model when practicing the present invention. It is also to be understood that the term “accurate” may encompass the term “realistic”, to describe an ability of the economic model derived in accordance with the present invention determine an evolution of an economic state from the economic model.

As used herein, the term “controllable”, refers to an economic model that is capable of being manipulated and/or controlled to achieve a desired outcome of the economic state. Likewise, the term “stable” refers to an economic model that is capable of achieving a consistent and reproducible result within a given set of boundaries and/or parameters. As used herein, the term “continuous” refers to an economic model that is capable of incorporating an infinite number of values and/or variables along a scale.

It has also been discovered that the incorporation of the economic variables, economic state functions and/or economic strategies into the economic model forms an econometric meter that is effective (1) to accurately describe the relationship(s) between the economic variable(s), economic state function(s) and/or economic strategies, (2) to display the outcome of their relationship(s), (3) to monitor the economic state function(s), economic variable(s) and/or economic strategies, (4) to monitor the relationship(s) between the economic state function(s), economic variable(s) and/or economic strategies, (5) to analyze the economic variable(s), economic state function(s) and/or economic strategies, (6) to analyze the relationship(s) between the economic variable(s), economic state function(s) and/or economic strategies, (7), to predict the effect of one or more changes in the economic variable(s), economic state function(s) and/or economic strategies on the economic state, and (8) to simulate the relationship between the economic variable(s), economic state function(s) and/or economic strategies. The meter 24 also helps simulate one or more situations prior to implementation of an economic strategy for the economic state.

The terms “economy” or “economic state” or “economic state of a system” or “economic system”, as used herein, collectively describes an arrangement or an organized set of procedures and/or principles that may be used to decide how to utilize a limited amount of a resource to satisfy a desire for a system at a specified time and/or over a specified time period. It is also to be understood that the terms “economy” or “economic state” or “economic state of a system” or “economic system” may be used interchangeably throughout the application. Some non-exhaustive examples of systems include an individual, an individual household, a private firm, a corporation, a business, a public firm like a government, a nation, a country, a land, an industry, a market, or any combination of any of these.

When the system is a nation, the economic system may generally depend primarily on market principles of supply and demand. By supply is meant an ability or willingness of a supplier to make available one or more goods and/or services for sale. By demand is meant an ability or willingness of a buyer to purchase one or more goods and/or services. In addition, several non-exhaustive desired characteristics of the economic state of a nation include maximum and/or full employment, minimum inflation, maximum economic growth, or zero or surplus balance of payment(s).

The model 16 of the economic state of a nation, a land, a country, or any combination of any of these, hereinafter referred to as “nation” may include one or more economic state function(s). The term “economic state function” as used herein, refers to one or more component(s) that are required for production of a good and/or service. In addition, economic state function(s) may be used to characterize the economic state of a nation when practicing the present invention. Some non-exhaustive examples of economic state functions include income or gross domestic product (GDP) or gross national product (GNP), rate of interest (R), employment (L), capital stock (K), price (p), cumulative balance of payment (E), or any combination of any of these. Preferably, the economic state of a nation (x) is a state vector that includes income (y), rate of interest (R), employment (L), capital stock (K), price (p), and cumulative balance of payment (E) as generally depicted by the following equation:

x={y, R, L, K, p, E}

Preferably, the economic state function(s) are included as part of the model 16 in a form that permits the model 16 (1) to be dynamic, (2) to incorporate both time-discrete or time-continuous equations, (3) to be controllable prior to and after introduction of other economic state function(s), economic variable(s) or economic strategies, (4) to be stable prior to and after introduction of other economic state function(s), economic variable(s) or economic strategies, (5) to be hereditary or be capable of accommodating and/or manipulating historical data, and (6) to accurately forecast one or more time-based patterns of activity of the economic state.

As an example, the economic state function(s) may be graphically plotted as a function of time. Next, one or more equation(s) that describes the time based graphical plot of the economic state function are determined. The equation(s) that describe the time-based graphical plot of the economic state function may be characterized as a difference equation, a differential equation, a mixed-differential-difference equation, a functional differential equation, or any combination of any of these. Preferably, the equation(s) that characterize the time-based graphical plot of the economic state function(s) are one or more functional differential equation(s).

Furthermore, economic state functions are typically interrelated and may be defined in terms of other economic state functions. Therefore, functional differential equations are beneficial since they are capable of realistically and accurately characterizing the time-based graphical plots of economic state functions. In addition, functional differential equations may undergo an optional adaptation and/or modification to fit the functional differential equation(s) to the time-based graphical plot of the economic state function(s) and permit an even more accurate and realistic derivitization of the economic model 16.

Still more preferably, the functional differential equation(s) derived by the Inventor in an article entitled “Volterra Integodifferential Neutral Dynamics for the Growth of Wealth of Nations. A Controllability Theory” (Indian J. Pure Appl. Math., 29(7) 723-799, July 1998), or the book entitled “Optimal Control of the Growth of the Wealth of Nations ” or the book entitled “Differential Models And Neutral Systems For Controlling The Wealth of Nations”, which are incorporated herein it its entirety by reference, are used to derive the functional differential equation(s) that characterize each economic state function of the economic state.

As used herein, the “gross domestic product” or “gross national product” or “income” or “aggregate supply” refers to a total market value or total income based upon all goods and/or services produced by a system during a specified period. The terms “gross domestic product” or “GDP” or “gross national product” or “GNP” or “income” may be used interchangeable throughout the present invention. In addition, “y” has been designated for either the GDP, GNP or income in accordance with the present invention.

The income (y) is an economic state function of the economic state (x) that is typically based upon time (t). Furthermore, income (y) may be characterized in the form of one or more functional differential equations that are capable of incorporating time-discrete and/or time-continuous values. In addition, income (y) is generally influenced by market principles of supply and demand.

Income (y) may be mathematically derived and/or defined in terms of other economic state functions that may also be in the form of functional differential equations, such as the rate of interest (R), labor (L), capital stock (K), price (p), cumulative balance of payment (E), or any combination of any of these. While income (y) may be mathematically derived in terms of economic state functions, such as the rate of interest (R), labor (L), capital stock (K), price (p), cumulative balance of payment (E), or any combination of any of these, it is to be understood that a graphical plot of one or more values of the income (y) as a function of time, followed by preferred methods of regression analysis of this graphical plot to derive one or more functional differential equations that characterize the pattern of income (y) as a function of time, and methods of regression analysis to determine any coefficients of the equation(s), may be substituted in place of the mathematical function of income (y) in accordance with the present invention, while still realizing benefits of the present invention.

As used herein, the terms “rate of interest (R)” or “interest rate (R)” refer to a rate or charge for a loan. The rate of interest (R) may also be characterized in the form of one or more functional differential equation(s). In addition, the rate of interest (R) may be mathematically derived and/or defined in terms of economic state functions, such as economic factors that are not dependent on income (y), a current rate of interest R(t), a cumulative past history of interest rates, a rate of change of the interest rate, one or more previous interest rates, a fraction of current money supply and/or one or more past money supply values used for the interest rate, a fraction of money demand and/or past money demand values used for the interest rate, or any combination of any of these.

While the interest rate (R) may be mathematically derived in terms of economic state functions, such as an autonomous interest rate, a current rate of interest, a cumulative past history of interest rates, a rate of change of the interest rate, one or more previous interest rates, a fraction of current money supply and/or one or more past money supply values used for the interest rate, a fraction of money demand and/or past money demand values used for the interest rate, or any combination of any of these, it is to be understood that a graphical plot of one or more values of the interest rate (R) as a function of time, followed by preferred methods of regression analysis of this graphical plot to derive one or more equations that characterizes the pattern of the interest rate (R) as a function of time, and methods of regression analysis to determine any coefficients of the equation(s) may be substituted in place of the mathematical function of the interest rate in accordance with the present invention, while still realizing benefits of the present invention.

As used herein, the terms “labor (L)” or “employment (L)” or “human capital” refer to a contribution to a productive activity made by a human work force to provide a good and/or a service. Employment (L) is an economic state function of the economic state (x) that is typically based upon time (t). Furthermore, employment (L) may be characterized in the form of one or more functional differential equations that are capable of incorporating time-discrete and/or time-continuous values. Employment (L) may be mathematically derived and/or defined as a function of current employment (L), a cumulative past history of employment, a fraction of current and/or past interest rate (R) used for employment, one or more previous values for employment, a fraction of current and/or past income used for employment, or any combination of any of these.

While the employment (L) may be mathematically derived in terms of economic state functions, such as current employment (L), a cumulative past history of employment, one or more previous values for employment, a fraction of current and/or past interest rate (R) used for employment, a fraction of current and/or past income used for employment, or any combination of any of these, it is to be understood that a graphical plot of one or more values of the employment (L) as a function of time, followed by preferred methods of regression analysis of this graphical plot to derive one or more equations that characterizes the pattern of employment (L) as a function of time, and methods of regression analysis to determine any coefficients of the equation(s) may be substituted in place of the mathematical function of the employment (L) in accordance with the present invention, while still realizing benefits of the present invention.

As used herein the term “price (p)” refers to a value amount of one or more goods and/or services. The price (p) is an economic state function of the economic state (x) that is typically based upon time (t). Furthermore, price (p) may be characterized in the form of one or more functional differential equations that are capable of incorporating time-discrete and/or time-continuous values.

The price (p) of the good and/or service may be derived and/or defined as a function of autonomous price, which is independent of income current price, rate of change of a price or inflation, a cumulative past history of one or more prices, an exchange rate, a fraction of money supply used for pricing, a fraction of one or more import price level(s) in foreign currency, productivity, a fraction of money demand used for pricing, a fraction of a rate of change of money supply used for pricing, a money wage rate, or any combination of any of these.

While the price (p) may be mathematically derived in terms of factors, such as the autonomous price, current price, rate of change of a price or inflation, a cumulative past history of one or more prices, an exchange rate, a fraction of money supply used for pricing, a fraction of one or more import price level(s) in foreign currency, productivity, a fraction of money demand used for pricing, a fraction of a rate of change of money supply used for pricing, a money wage rate, or any combination of any of these, it is to be understood that a graphical plot of one or more values of the price (p) as a function of time, followed by preferred methods of regression analysis of this graphical plot to derive one or more equations that characterizes the pattern of the price (p) as a function of time, and methods of regression analysis to determine any coefficients of the equation(s) may be substituted in place of the mathematical function of the price (p) in accordance with the present invention, while still realizing benefits of the present invention.

As used herein the term “cumulative balance of payment (E) refers to a balance of a nation's trade and financial transactions with one or more other nations over a specified period of time. The cumulative balance of payment (E) is an economic state function of the economic state (x) that is typically based upon time (t). Furthermore, the cumulative balance of payment (E) may be characterized in the form of one or more functional differential equations that are capable of incorporating time-discrete and/or time-continuous values.

The cumulative balance of payment (E) may be derived and/or defined as a function of autonomous cumulative balance of payment, a fraction of current and/or past income used for the cumulative balance of payment, a fraction of the current and/or past interest rates used for the cumulative balance of payment, a fraction of the exchange rate used for the cumulative balance of payment, a fraction or the current and/or past labor used for the cumulative balance of payment, a fraction of a cumulative past history of labor used for the cumulative balance of payment, a fraction of the transportation or distance between trading partners used for the cumulative balance of payment, a fraction of a current tariff used for the cumulative balance of payment, a fraction of the past cumulative balance of payment, or any combination of any of these.

While the cumulative balance of payment (E) may be mathematically derived in terms of economic state functions, such as autonomous cumulative balance of payment, a fraction of current and/or past income used for the cumulative balance of payment, a fraction of the current and/or past interest rates used for the cumulative balance of payment, a fraction of the exchange rate used for the cumulative balance of payment, a fraction or the current and/or past labor used for the cumulative balance of payment, a fraction of a cumulative past history of labor used for the cumulative balance of payment, a fraction of the transportation or distance between trading partners used for the cumulative balance of payment, a fraction of a current tariff used for the cumulative balance of payment, a fraction of the past cumulative balance of payment, or any combination of any of these, it is to be understood that a graphical plot of one or more values of the cumulative balance of payment (E) as a function of time, followed by preferred methods of regression analysis of this graphical plot to derive one or more equations that characterizes the pattern of the cumulative balance of payment as a function of time, and methods of regression analysis to determine any coefficients of the equation(s) may be substituted in place of the mathematical function of the cumulative balance of payment (E) in accordance with the present invention, while still realizing benefits of the present invention.

As noted, preferred methods of regression analysis may be used to determine the functional differential equations and coefficients of the economic state functions. An example of a computer-based method of regression analysis that may be used when practicing the present invention is the MATLAB® Linear Regression Model of System Identification Toolbox of Ljung that is available from The Mathworks of Natick, Massachusetts. Alternatively, MATLAB programs from Andrew Grace Optimization Toolbox may also be used to create computer-based methods of regression analysis.

The principle of supply and demand states that the rate of change of income (y) is proportional to the difference between aggregate supply (y) and aggregate demand (Z). Aggregate demand (Z) is typically a function of one or more economic variables. Some non-exhaustive examples of economic variables that may be used to define aggregate demand (Z) in accordance with the present invention include consumption (C), investment (I), government spending (G), net export (X), an income-expenditure accounting identity (ML), net government transfer of capital to foreigners and firms (T), tariffs (tau), exchange rate (e), aggregate distance between trading partners or transportation (d), money supply (M), inflation (pie), public investment (V), public consumption, private investment (J), money demand (L), export function (x), import (m), or any combination of any of these. As an example, aggregate demand (Z) may be defined below:

Z(t)=C(t)+I(t)+X(t)+G(t)

As used herein, the term “consumption (C)” refers to a utilization of one or more goods and/or services. The consumption (C) may be characterized as a continuous function of time. In addition, the consumption (C) may be mathematically derived and/or defined in terms of economic variables, such as autonomous consumption, a fraction of current, past and/or after tax income used for consumption, a cumulative past history of consumption, one or more previous consumption values, a fraction of a cumulative past history of previous income used for consumption, a fraction of current and/or one or more previous tax values used for consumption, a fraction of the current and/or one or more previous interest rates used for consumption, a rate of change of consumption, or any combination of any of these.

As used herein, the term “autonomous” refers to a value of an economic state function, such as interest rate (R), net export (X), government spending (G), capital stock (K), employment (L), cumulative balance of payment (E), or any combination of any of these, that does not depend on income (y). As used herein, the terms “previous” or “past history” refer to one or more values of an economic variable, such as investment (I), consumption (C), interest rate (R), net export (X), government spending (G), capital stock (K), employment (L), cumulative balance of payment (E), net government transfer of capital to foreigners and firms (T), tariffs (tau), exchange rate (e), aggregate distance between trading partners or transportation (d), money supply (M), inflation (pie), public investment (V), public consumption, private investment (J), money demand (L), export function (x), or any combination of any of these, that was obtained and/or derived in a specified time period before a current time.

While consumption (C) may be mathematically defined and/or derived in terms of autonomous consumption, a fraction of current, past and/or after tax income used for consumption, a cumulative past history of consumption, one or more previous consumption values, a fraction of a cumulative past history of previous income used for consumption, a fraction of current and/or one or more previous tax values used for consumption, a fraction of the current and/or one or more previous interest rates used for consumption, a rate of change of consumption, or any combination of any of these it is to be understood that a graphical plot of one or more values of consumption as a function of time, followed by preferred methods of regression analysis of this graphical plot to derive one or more equations that characterizes the pattern of consumption as a function of time, and methods of regression analysis to determine any coefficients of the equation(s) may be substituted in place of the mathematical function of consumption in accordance with the present invention, while still realizing benefits of the present invention.

As used herein the term “private investment (I)” refers to a value of money (capital) invested by a private (non-government) sector to produce one or more goods and/or services. The investment (I) may be characterized as a continuous function of time. The investment (I) may be mathematically defined in terms of autonomous investment, which is independent of income yet possibly dependent upon an entrepreneur's perception about a future economic state, a time-dependent private investment function that includes a cumulative history of past private investments, a fraction of the current and/or past interest rates used for private investment, a fraction of the current and/or past income used for private investments, a fraction of current labor and/or past labor used for private investment, a fraction of current capital stock used for-private investment, a fraction of money demand used for private investment or any combination of any of these.

While the private investment (I) may be mathematically derived in terms of autonomous investment, a time-dependent private investment function that includes a cumulative history of past private investments, a fraction of the current and/or past interest rates used for private investment, a fraction of the current and/or past income used for private investments, a fraction of current labor and/or past labor used for private investment, a fraction of current capital stock used for private investment, a fraction of money demand used for private investment or any combination of any of these, it is to be understood that a graphical plot of one or more values of the private investment as a function of time, followed by preferred methods of regression analysis of this graphical plot to derive one or more equations that characterizes the pattern of the private investment as a function of time, and methods regression analysis to determine any coefficients of the equation(s) may be substituted in place of the mathematical function of the private investment in accordance with the present invention, while still realizing benefits of the present invention.

As used herein the term “net export (X)” refers to a total export of one or more goods and/or services minus a total import of one or more goods and/or services for a system. As used herein, the term “export (x)” or “export function (x)” refers to one or more goods and/or services that are transported from a system to another system. Similarly, the term “import (m)” refers to one or more goods and/or services that are transported into a system from another system.

The net export (X) may be characterized as a continuous function of time. Furthermore, the net export (X) may be derived and/or defined as a function of autonomous net export, current net export, a rate of change of net export, a fraction of current and/or past income used for net export, a fraction of the interest rate used for net export, a fraction of current and/or past labor used for net export, a fraction of a cumulative past history of labor used for net export, a fraction of private control instruments used for net export, a fraction of tariffs used for net export, a fraction of exchange rate used for net export, a fraction of foreign credit used for net export, a fraction of any preferential arrangements used to reduce any barriers to trade and enhance any trade flows between two or more systems, a fraction of an aggregate distance between trading partners or transportation used for net export, or any combination of any of these.

While the net export (X) may be mathematically derived in terms of factors, such as autonomous net export, current net export, a rate of change of net export, a fraction of current and/or past income used for net export, a fraction of the interest rate used for net export, a fraction of current and/or past labor used for net export, a fraction of a cumulative past history of labor used for next export, a fraction of private control instruments used for net export, a fraction of-tariffs used for net export, a fraction of exchange rate used for net export, a fraction of an aggregate distance between trading partners or transportation used for net export, a fraction of foreign credit used for net export, a fraction of any preferential arrangements used to reduce any barriers to trade and enhance any trade flows between two systems, or any combination of any of these, it is to be understood that a graphical plot of one or more values of the net export as a function of time, followed by preferred methods of regression analysis of this graphical plot to derive one or more equations that characterizes the pattern of the cumulative balance of payment as a function of time, and methods of regression analysis to determine any coefficients of the equation(s) may be substituted in place of the mathematical function of the net export (X) in accordance with the present invention, while still realizing benefits of the present invention.

After determining the functional differential equations that characterize the income (y), capital stock (K), rate of interest (R), employment (L), price (p), and cumulative balance of payment (E), one or more equations that describe the economic state (x) are obtained. The equations that describe the economic state (x) in terms of the income (y), capital stock (K), rate of interest (R), employment (L), price (p), cumulative balance of payment (E) may be derived by transforming the economic state (x), income (y), capital stock (K), rate of interest (R), employment (L), price (p), and cumulative balance of payment (E) into a state vector. Next, the state vector of income (y), capital stock (K), rate of interest (R), employment (L), price (p), cumulative balance of payment (E) are solved simultaneously to obtain the economic state (x). Therefore, the economic state (x) is derived from a functional differential equation that includes income (y), capital stock (K), rate of interest (R), employment (L), price (p), cumulative balance of payment (E) as economic state functions. The economic state (x) may also be characterized as a 6-component state vector that includes (y), capital stock (K), rate of interest (R), employment (L), price (p), cumulative balance of payment (E).

The economic state (x) may also include one or more economic strategies. Preferably, the economic strategies are used as controls that drive the economic state (x₀) from a point at time zero to a desired outcome state (x₁). Still more preferably, the economic strategies are used as controls that drive the economic state (x₀) to the desired economic state (x₁) in a minimum amount of time and with a minimum amount of resources.

The economic strategies typically include a government control strategy and a private control strategy. As used herein the term “government spending (G)” refers to a total value spent for one or more goods and/or services by a governing structure of a system. The term “government spending (G)” is also meant to encompass public investment and public consumption of one or more goods and/or services.

The government spending (G) may be characterized in the form of a functional differential equation. Furthermore, the government spending (G) may be derived and/or defined as a function of autonomous government spending, current government spending, public investment, public consumption, a rate of change of a cumulative past income, interest rate, employment, capital stock, or any combination of any of these.

While the government spending (G) may be mathematically derived in terms of autonomous government spending, current government spending, public investment, public consumption, a rate of change of a cumulate past income, interest rate, employment, capital stock, or any combination of any of these, it is to be understood that a graphical plot of one or more values of the government spending as a function of time, followed by preferred methods of regression analysis of this graphical plot to derive one or more equations that characterizes the pattern of the government spending as a function of time, and methods of regression analysis to determine any coefficients of the equation(s) may be substituted in place of the mathematical function of the government spending (G) in accordance with the present invention, while still realizing benefits of the present invention.

The economic state of a nation may also include one or more economic strategies. Preferably, the economic state (x) includes one or more economic strategies that are based upon one or more government control strategies, and one or more private control strategies. Still more preferably, the government control strategy and the private control strategy are used to steer or control the economic state from an initial state to a target state.

As used herein, the terms “government control strategy” or government intervention” or “government involvement” refer to an assumption or deliberate strategy implemented by a governing structure to influence economic activity. The government control strategy (q) typically involves the use of one or more government control instruments. Some non-exhaustive examples of government control instruments include taxes, autonomous government outlay (g₀), exchange rate (e), tariffs (tau), net government transfer of capital to foreigners and firms (T), aggregate distance between trading partners or transportation (d), money supply (M), preferential trade subsidies, arrangements, trade policies or any combination of any of these. Preferably, the government control strategy includes taxes, autonomous government outlay (g₀), exchange rate (e), tariffs (tau), net government transfer of capital to foreigners and firms (T), aggregate distance between trading partners or transportation (d), money supply (M), and preferential trade subsidies, arrangements, or trade policies as the government control instruments.

As used herein, the terms “private control strategy” or “private intervention”, or “private involvement” refer to an assumption or deliberate strategy implemented by the private sector (non-government sector) to influence economic activity. The private control strategy (sigma) typically involves the use of one or more private control instruments. Some non-exhaustive examples of private control strategies include labor productivity, wage rate, autonomous consumption, autonomous investment, autonomous net export, autonomous real money demand, intercept income export, intercept income consumption, intercept prices, or any combination of any of these. Preferably, the private control strategy includes labor productivity, wage rate, autonomous consumption, autonomous investment, autonomous net export, autonomous real money demand, intercept income export, intercept income consumption, and intercept prices as the private controls strategies.

Next, a determination of one or more equations that characterize both the government control strategy and the private control strategy is performed by the user 12. In order to derive the equations that define the government control strategy, the government control instruments that include taxes, autonomous government outlay (g₀), exchange rate (e), tariffs (tau), net government transfer of capital to foreigners and firms (T), aggregate distance between trading partners or transportation (d), money supply (M), preferential trade subsidies, arrangements, trade policies are introduced into an 8 by 6 matrix that permits transformation of the government control strategy into a state vector having 6 dimensions based on the economic state functions. The 8 by 6 matrix further permits the user 12 to understand what government control instruments influence the government control strategy.

Similarly, in order to derive the equations that define the private control strategy, the private control strategy that includes labor productivity, wage rate, autonomous consumption, autonomous investment, autonomous net export, autonomous real money demand, intercept income export, intercept income consumption, intercept prices are introduced into a 9 by 6 matrix that permits transformation of the private control strategy into a state vector having 6 dimensions based on the economic state functions.

The incorporation of one or more methods of matrix analysis for a state vector permits an efficient method to determine what economic strategy is to be incorporated as part of the economic model 16 so that the economic model 16 is controllable based upon a full rank of a resultant control matrix from the government control and private control strategies. In fact, controllability of the economic model 16 occurs by determining the rank of the matrices. The full rank of the resultant control matrix obtained from the government control and private control strategies indicates and/or ensures controllability of the economic model 16 when practicing the present invention.

An instantaneous private firm's response to any government intervention is an example of an economic strategy that may be used in accordance with the present invention to derive the model 16, and therefore the econometric meter 24. Preferably, the private firm's response to the government intervention, also referred to as the stroboscopic strategy, is used to define the economic strategy used to derive the model 16.

As noted above, the economic state functions, the economic variables and the economic strategies may be combined to form a time-based economic model of the economic state of the nation. The economic model may then be transformed into a neutral dynamic game of pursuit with the economic state being a function of income (y), interest rate (R), employment (L), capital stock (K), cumulative balance of payment (E) or any combination of any of these, in order to facilitate programming and/or simulation the economic model 16. In addition, the equations used to derive the economic state (x) may also describe other dynamic systems, as noted above for income (y), interest rate (R), employment (L), capital stock (K), cumulative balance of payment (E), for example that may each be used individually or in combination to derive the model 16 when practicing the present invention.

In the neutral dynamic game of pursuit, the government control strategy may be designated as a ‘quarry” or “q” while the private control strategy may be designated as a “pursuer” or “p”. As an example, the economic state of a system may include the equation below:

x(t)−A₋₁x(t−h)=A₀x(t)+A₁x(t−h)+B₁p+B₂q

where A₋₁, A₀, A₁, B₁, and B₂ are coefficients, x(t) is the economic state at time t, x(t-h) is a previous value for the economic state, p is the private control strategy and q is the government control strategy. In addition, the coefficients A₋₁, A₀, A₁, B₁, and B₂ are also determined through methods of regression analysis.

When an electronic circuit has been identified that displays a current and or voltage pattern as a function of time that is similar, and preferably identical to the model 16 of the economic state of the nation, the electronic circuit is chosen to model the model 16 of the economic state and is thereafter transformed into the modeled-electronic circuit 20 of the present invention. Thus, the model 16 of the economic state may be characterized as analogs of one or more current and voltage equations, such as current and voltage equations in lossless transmission lines, tunnel diode circuit, equations derived from Kirchoff's current law with phase shifting mechanisms or even simpler circuits. Some other non-exhaustive examples of circuits that may be used in accordance with the present invention are disclosed in the Inventor's books entitled “Differential Models and Neutral Systems for Controlling The Wealth of Nations” and “Optimal Control of the Growth of the Wealth of Nations” which have been incorporated herein in their entirety by reference.

Next, the modeled-electronic circuit 20 may be used to assemble an apparatus, such as a computer processing unit or a simulator, to form the meter 24. Therefore, when an economic model that characterizes the economic state of a nation in terms of income (y), interest rate (R), employment (L), capital stock (K), price (p), cumulative balance of payment (E) or any combination of any of these, is combined with economic strategy that includes a private control strategy depending on autonomous consumption, autonomous investment, autonomous net export, autonomous real money demand, intercept income export, intercept income consumption, intercept prices, or any combination of any of these that responds to a government control strategy depending on taxes, autonomous government outlay, exchange rate, tariff, transportation, money supply, preferential trade arrangements, or any combination of any of these, the model 16 may be controllable.

Furthermore, from any initial economic state (x₀) that depends on initial states for income (y₀), interest rate (R₀), employment (L₀), capital stock (K₀), price (p₀), cumulative balance of payment (E₀) or any combination of any of these, the user 12 may select any target x₁ at target time t₁ using the private (p) and government control strategies (q) even if such control strategies are subjected to scarcity, limitations, or constraints.

In addition, the user 12 may be capable of minimizing a time or a resource required to reach the target x₁ that depends on target states for income (y₁), interest rate (R₁), employment (L₁), capital stock (K₁), price (p₁), cumulative balance of payment (E₁) or any combination of any of these using the meter 24. In addition, the meter 24 is capable of displaying the change in economic states, along with one or more outcomes based upon changes to the model 16 in a computer graphical form through one or more computer languages via a television monitor.

A method of using the econometric meter in accordance with the present invention is generally depicted at 100 in FIG. 2. In the method 100, a user 112 constructs an econometric meter (step 114) using historical data to define the dynamic equations of the economic state and form a model of the economic state of a nation. Next, the user 112 determines if private control instruments or the private control strategy dominates or is more influential than government control instruments or the government control strategy (step 116). Next, the user 112 defines a constrained control set for the economic state by determining a maximum range of possible values for each control instrument of either the government control strategy or the private control strategy.

As an example, the user 112 may define the constrained control set to include the range of possible values of each control instrument to be a negative maximum value to a positive maximum value. The constraint control set, therefore, would take on the following form:

Q or P=[−maximum value of control instrument, +maximum value of control instrument]

where Q is the quarry and P is the pursuer. For each control instrument, the user 112 similarly obtains other ranges of possibilities as defined above, for example. Preferably, setting the constraint control set for each control instrument includes all possible values between a negative maximum value of the control instrument and a positive maximum value of a control instrument is used in accordance with the present invention.

It should be noted that when the user 112 determines or sets the constraint control set for the government control strategy and the private control strategy, the control instruments used by the government control strategy and the private control strategy are limited in relation to what may be available. Therefore, the values for each government control instrument strategy may not go beyond what is available, nor can the value for each private control instrument go beyond what is available. As an example, if the maximum value for Taxes is $200 billion dollars, the value for Taxes may not go beyond $200 billion dollars. Similarly, a maximum value for Taxes of $200 billion dollars indicates that no more than $200 billion dollars may be used in subsidies, which is the negative maximum value of taxes.

Next, the user 112 may program the optimum economic control strategy using private and government control instruments (step 120). Preferably, the economic strategy includes a set of a private control strategy that dominates, or is more influential than a set of a government control strategy on the economic state of a nation. In other words, the economic control strategy should be dominated by private control instruments rather than government control instruments when programing the optimum economic control strategy.

For programming the optimum economic control strategy, the user 112 identifies an initial economic state (x₀) and a target economic state (x₁) (step 122). After identifying both initial and target economic states, the user 112 may then use set of the economic strategy dominated by private control instruments to steer the initial economic state to the desired economic target state. In addition, the user 112 may confirm the controllability of the economic state by determining if the appropriate range of possibilities of each control instrument is within the negative maximum value of the control instrument and the positive maximum value of the control instrument, and whether the control matrix has full rank.

The present invention is more particularly described in the following example for the US economy presented below. Economic data from International Statistic yearbook was used to derive an economic model, and the resulting coefficients. A software program to construct the economic model, the econometric meter, define coefficients, and obtain the state vector is presented below as well:

[image]

[image]

[image]

[image]

[image]

[image]

[image]

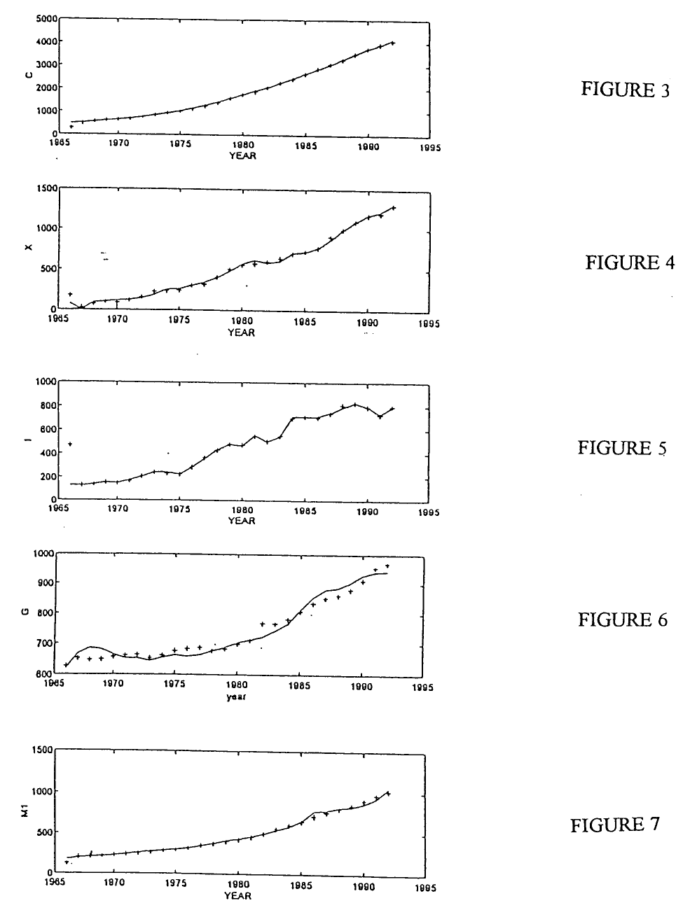

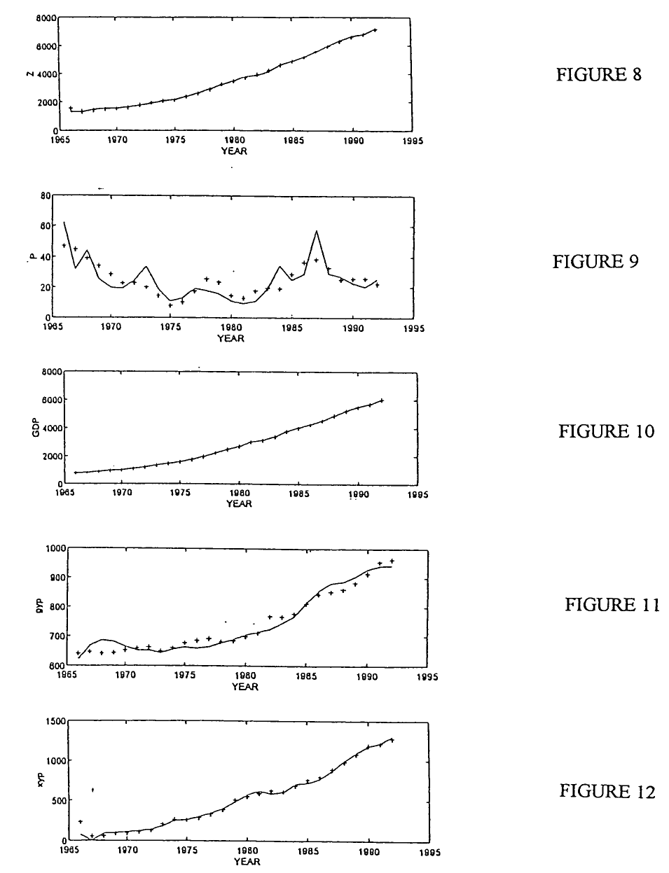

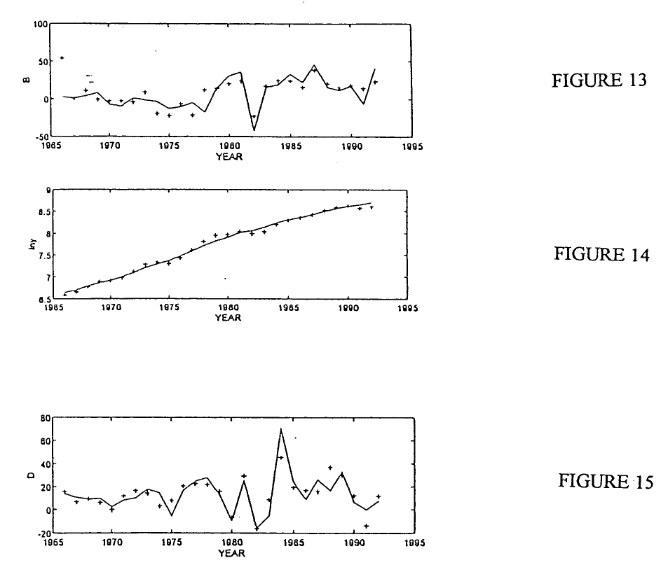

In the above example, the rank (b) was 6, therefore the economic model is controllable. In addition, FIGS. 3-15 show how accurate the economic model is in predicting an equation that fits the data. FIGS. 3-15 each illustrate an economic variable as a function of time. The US variables are private consumption, exports, investments, government consumption, money demand, aggregate demand, consumer prices, income, income/government, income/export, balance of payment, long (income), and increase in stock. The “real” data, or data obtained from the International Financial Statistic Yearbook, 1994, for USA, while the economic model data are the “+” markings.

In addition, using the predict command, the economic state functions, and therefore the economic state may be extrapolated out to 4 years from the current time, and still produce model data points that fit the economic model. Similar results, such as controllability of the economic model, and therefore, of the econometric meter were observed when working with economic data from United Kingdom, Italy, Germany, Nigeria, South Africa, Austria, China, Brazil, and Canada.

Although the present invention has been described with reference to preferred embodiments, workers skilled in the art will recognize that changes may be made in form and detail without departing from the spirit and scope of the invention.

1. A method of constructing an econometric meter, the method comprising:
constructing an economic model of an economic state that includes a state vector of the economic state comprising income, employment, cumulative balance of payment, rate of interest, capital stock, and price;
designing at least one electronic circuit to form a modeled-electronic circuit, wherein a current or voltage pattern of the electronic circuit is capable of simulating the economic model; and
assembling the econometric meter, wherein the econometric meter comprises the modeled-electronic circuit, and wherein the econometric meter is capable of monitoring the economic state.

2. The method of claim 1 wherein the economic model is controlled by an economic strategy comprising a private control strategy that dominates a government control strategy.

3. A method of constructing an economic model of a nation, the method comprising:
constructing an economic model that comprises a state vector in the form of x(t)−A₋₁x(t-h)=A₀x(t)+A₁x(t-h)+B₁p+B₂qx, wherein the economic model is effective to define an economic state of a nation.

4. A method of using an econometric meter, the method comprising:
constructing an econometric meter, wherein the econometric meter comprises an economic model, wherein the economic model comprises at least one state vector defined in terms of income, employment, cumulative balance of payment, rate of interest, capital stock, and price;
determining an economic strategy;
computing constraints;
programming the economic strategy;
identifying an initial economic state and a target economic state; and
determining controllability of the target economic state.
